(19) United States
(12) Patent Application Publication
(10) Pub. No.: US 2026/0351645 A1
(43) Pub. Date: Nov. 5, 2026

(54) A SOLID OXIDE CELL RESISTANT TO HIGH-TEMPERATURE ISOTHERMAL DEGRADATION

(71) Applicant: DANMARKS TEKNISKE UNIVERSITET, Kongens Lyngby (DK)

(72) Inventors: Peyman KHAJAVI, Kongens Lyngby (DK); Henrik Lund FRANDSEN, Kongens Lyngby (DK); Peter Vang HENDRIKSEN, Kongens Lyngby (DK)

(21) Appl. No.: 19/120,269

(22) PCT Filed: Oct. 12, 2023
(86) PCT No.: PCT/EP2023/078410

§ 371 Date: Apr. 11, 2025

(30) Foreign Application Priority Data
Oct. 14, 2022 (EP) 22201521.6

(51) Int. Cl. H01M 8/1253; C25B 13/07; H01M 8/12

(52) U.S. Cl. CPC H01M 8/1253; C25B 13/07; H01M 2008/1293; H01M 2300/0077

(57) ABSTRACT

The present invention relates to a solid oxide cell, such as a solid oxide fuel cell (SOFC) or a solid oxide electrolyser cell (SOEC), containing at least one structural component comprising doped zirconia, which includes more than 80 Vol % of metastable transformable tetragonal zirconia ceramic materials, having a superior resistance to high-temperature isothermal degradation.

### FIELD OF THE INVENTION

The present invention relates to a solid oxide cell, for example a solid oxide fuel cell (SOFC) or a solid oxide electrolyser cell (SOEC), containing, as structural support or as part of an electrode or electrolyte, transformable metastable tetragonal zirconia ceramic materials.

### BACKGROUND OF THE INVENTION

Solid oxide cells (SOCs), such as SOFCs and SOECs, are high temperature electrochemical devices that can be used for energy conversion applications with a high electrical efficiency.

Due to the high operational temperatures involved, SOCs are subjected to various stresses during fabrication and stacks-assembly and, more importantly, during operation.

High temperature and non-homogeneous temperature distribution may induce mechanical stresses within SOCs leading to micro cracks and defects, or to propagation of pre-existing cracks, thus causing mechanical failure of the systems.

Mechanical reliability is therefore crucial for optimal operation of SOCs.

This indicates the necessity to produce strong and degradation resistant SOCs, where the mechanical strength can be maintained, allowing for long-term and reliable operation.

Zirconia ceramics having high fracture toughness and strength have shown promising applicability within SOCs.

High fracture toughness and strength in zirconia ceramics can be achieved by the tetragonal to monoclinic phase transformation when exposed to mechanical stress. For this so-called “transformation toughening mechanism” to occur, the tetragonal polymorph needs to be in the metastable form, i.e. having the capability to transform to the monoclinic phase. The phase transformation can be induced by stress, and the volume expansion occurring during the phase transformation may arrest crack propagation, effectively increasing material toughness.

Nevertheless, the metastable tetragonal zirconia-based ceramics are prone to isothermal degradation, a phenomenon in which the tetragonal to monoclinic phase transformation occurs gradually, even without an applied stress. The phenomenon is particularly accelerated in the presence of humidity and is well known to occur at low temperatures, i.e. T<350 °C.

The driving force for the transformation reduces as temperature increases. In addition, isothermal degradation has in many scientific works been reported to be negligible at high temperatures (>400 °C). It has therefore been the general expectation that above ca. 400 °C this would not pose a technical problem for SOCs. The inventors have observed that, contrary to the common expectations in the field, even for operational temperatures in the technologically preferred range typically around 700 °C, an undesired non stress induced phase transformation may take place. This leads to a significant weakening of the material and consequent failure of SOCs may be observed during operation.

Currently, as observed by the inventors, the long-term mechanical reliability of the SOCs comprising zirconia ceramics is in fact limited by the high-temperature isothermal degradation of their tetragonal doped-zirconia components during operation. Depending on the operating conditions, i.e. temperature and atmosphere, the SOCs have a safe operation window of approximately 5-10 kh, while the lifetime of the cells is desired to be >40 kh.

Hence, improving the long-term mechanical reliability of SOCs would be advantageous so as to enhance SOCs aging resistance.

In particular, a SOCs having superior resistance to high-temperature isothermal degradation, allowing for a longer operational time at temperatures above 350 °C, would be advantageous.

### OBJECT OF THE INVENTION

An object of the present invention is to provide an efficient and reliable SOC having a lifetime >40 kh when operated at temperatures above 350 °C, or more specifically in the range between 400 and 850 °C, for example in the range between 500 and 800 °C.

A further object of the present invention is to provide a SOC having high resistance to degradation, when operated at temperatures above 350 °C, thus providing and SOC having a long-term mechanical reliability.

An object of the present invention may also be seen as to provide an alternative to the prior art.

In particular, it may be seen as an object of the present invention to provide an SOC having an outstanding degradation resistance, when operated at temperatures above 350 °C, which solves the above mentioned problems of the prior art.

### SUMMARY OF THE INVENTION

The above described objects and several other objects are intended to be obtained in a first aspect of the invention by providing a solid oxide cell, such as a SOFC or SOEC, containing at least one structural component comprising doped zirconia wherein the doped zirconia has more than 80 vol % of a metastable tetragonal crystalline phase (t-phase) and has an average grain-size between 120-190 nm and wherein the solid oxide cell is configured to be operated at temperature above 350 °C, such as between 400 and 850 °C, thereby improving aging resistance at operational temperature between 400 and 850 °C.

The at least one structural component may be a porous structural component.

A porous structural component may be defined as a structural component having a porosity level in the oxidized form higher than 5%.

In some embodiments the solid oxide cell is configured to be operated at temperature above 400 °C, such as 450 °C.

The solid oxide cell of the invention has a superior resistance to high-temperature isothermal degradation, which is achieved through the tailoring of the grains of the doped zirconia ceramics.

The SOC of the invention has an outstanding degradation resistance, at operational temperature above 350 °C, such as between 400 and 850 °C, through the use of at least one structural component comprising doped zirconia, wherein the doped zirconia has more than 80 vol %, such as more than 90 vol %, of the t-phase and have an average grain-size between 120-190 nm.

The t-phase is referred herein as a metastable, i.e. transformable, tetragonal crystalline phase.

The t-phase grains are grains having the characteristic that, when a crack propagates in a ceramic containing them, the stress field around the propagating crack transforms the grains to the monoclinic phase, resulting in the transformation toughening effect in the ceramic (structural component).

The t-phase zirconia grains may be obtained by doping the zirconia with dopant cations.

The solid oxide cell of the invention, despite having a high percentage of doped zirconia in the t-phase, which is prone to isothermal degradation (as observed in the state-of-the-art materials), showed unprecedented resistance to high-temperature degradation by showing no substantial phase transformation into the monoclinic phase.

In some embodiments, the doped zirconia has less than 20 vol %, such as less than 10%, of other high temperature phases such as cubic phase (c-phase) and non-transformable tetragonal phase (t′-phase).

The c-phase and t′-phases are not prone to a considerable transformation to the monoclinic phase within the desired lifetime of SOCs, thus are not influenced by the isothermal degradation.

The solid oxide cell of the invention, despite having a very low percentage, such as less than 5%, of non-transformable high temperature phases, such as c-phase and t′-phase, showed unprecedented resistance to isothermal degradation.

In some embodiments, at least one structural component comprises doped zirconia having the formula Zr₁₋ₓ REₓ O_{2-δ}, wherein RE is the dopant cation and wherein x is a number between 0.04 and 0.15 and δ is a number between 0 and 0.09.

The values of x and δ vary depending on the type and concentration of the dopants used.

In some embodiments, at least one porous structural component comprises yttria doped zirconia having the formula Zr₁₋ₓYₓ O_{2-δ}, wherein Y is the dopant cation and wherein x is a number between 0.01 and 0.07, such as 0.04 and 0.07 and δ is a number between 0.005 and 0.035, such as between 0.02 and 0.035.

Accordingly, the doped zirconia may be or may comprise yttria doped zirconia containing yttrium, such as yttrium cations, in a range between 4 and 7 mol %, such as between 5.5 and 6.5 mol %, for example 5.8%.

In these embodiments, in which the zirconia is stabilized by using yttrium cations, the at least one structural component comprises doped zirconia having the formula Zr₁₋ₓYₓ O_{2-δ}, wherein x is a number between 0.04 and 0.07 and δ is a number between 0.02 and 0.035.

In some other embodiments, the doped zirconia comprises scandium, such as scandium cations, in a range lower than 14 mol %, such as between 8 and 14 mol %.

In some other embodiments, the doped zirconia is or comprises scandia doped zirconia containing scandium, such as scandium cations, in a range lower than 14 mol %, such as between 8 and 14 mol %.

In some further embodiments, the doped zirconia comprises cerium, such as cerium cations, in a range lower than 15 mol %, such as between 10 and 15 mol %.

In some further embodiments, the doped zirconia is or comprises ceria doped zirconia containing cerium, such as cerium cations, in a range lower than 15 mol %, such as between 10 and 15 mol %.

In these embodiments, in which the zirconia is stabilized by using cerium cations, the at least one structural component comprises doped zirconia having the formula Zr₁₋ₓ Ceₓ O_{2-δ}, wherein x is a number between 0.1 and 0.15 and δ is theoretically 0.

The at least one structural component may also comprise zirconia co-doped with two or more elements, e.g. zirconia co-doped with both Cerium and Scandium.

The at least one structural component comprising doped zirconia may also comprise Ytterbium in a range lower than 7 mol %, such as between 4 and 7 mol %.

In some embodiments, the at least one structural component comprising doped zirconia comprises Calcium in a range lower than 9 mol %, such as between 4 and 9 mol %.

In some further embodiments, the at least one structural component comprising doped zirconia comprises Magnesium.

In some embodiments, the at least one structural component comprises a composite system of nickel oxide and doped zirconia, such as NiO—(ZrO₂)_{0.97}(Y₂O₃)_{0.03}, (Zr_{0.942} Y_{0.058} O_{1.971}) or in short notation; NiO-3YSZ.

In some embodiments, the NiO-3YSZ composite system has a porosity level in the oxidized form between 5 and 40%, for example between 18 and 33%.

The composite system may have a porosity level in the oxidized form between 13 and 18%, such as 13.5%.

The at least one structural component may be or may comprise a fuel electrode structural component.

In some other embodiments, the at least one structural component is or comprises oxygen electrode structural component.

In some further embodiments, the at least one structural component is an electrolyte.

The first, and other aspects and embodiments of the present invention may each be combined with any of the other aspects and embodiments. These and other aspects of the invention will be apparent from and elucidated with reference to the embodiments described hereinafter.

### BRIEF DESCRIPTION OF THE FIGURES

The solid oxide cell according to the invention will now be described in more details with regard to the accompanying figures. The figures show one way of implementing the present invention and are not to be construed as being limiting to other possible embodiments falling within the scope of the attached claim set.

FIG. 1 shows a graphical illustration of an example of a solid oxide cell according to the invention.

FIG. 2 shows the formation of monoclinic phase during operation of a solid oxide cell comprising Nickel oxide/Yttria-stabilized zirconia (Ni(O)-3YSZ) having an average grain size of 239 nm.

FIG. 3 shows SEM images of different NiO-3YSZ samples with different average grain size of 3YSZ.

### DETAILED DESCRIPTION OF AN EMBODIMENT

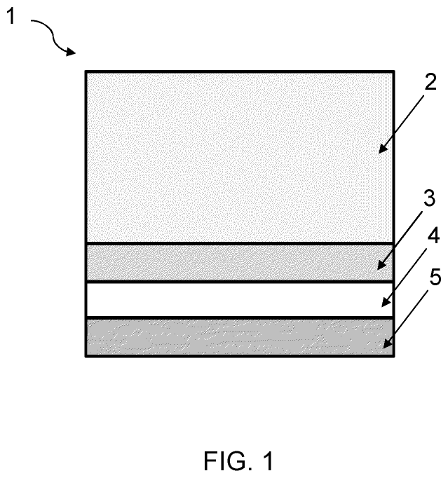

FIG. 1 shows a graphical illustration of an example of a solid oxide cell 1 according to the invention, comprising, as structural component, a porous structural support 2.

The solid oxide cell 1 also comprises a porous fuel electrode 3, a dense electrolyte 4 and a porous oxygen electrode 5.

According to the invention, the structural support comprises doped zirconia such as Nickel oxide/Yttria-stabilized zirconia (Ni(O)-3YSZ).

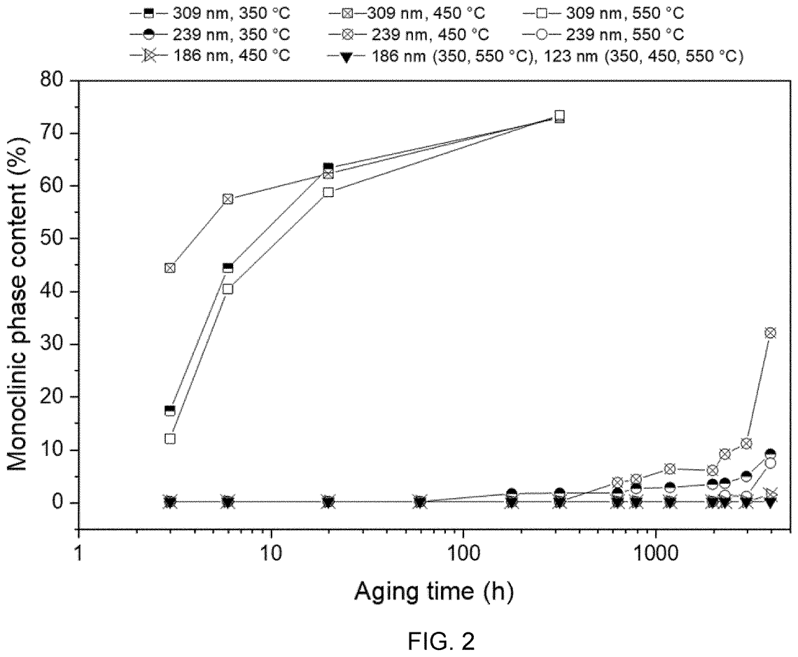

FIG. 2 is a graph plotting the percentage of monoclinic phase vs time of operation in hours, i.e. aging time (h), for a solid oxide cell comprising Nickel oxide/Yttria-stabilized zirconia (Ni(O)-3YSZ) having an average grain size of 239 nm.

The graph shows the formation of monoclinic phase at three different operational temperatures, i.e. 350 °C, 450 °C and 550 °C.

The monoclinic phase content formed in the samples with different average grain size during high-temperature aging experiments as a function of aging time is shown according to the following symbols: at 350 °C (half-up symbols), 450 °C (x-Center symbols), and 550 °C (open symbols).

For the samples with an average grain size of 239 nm at all three testing temperatures, it can be easily seen that a monoclinic phase forms; within <500 h at 350 °C and 450 °C, and after ≈2500 h at 550 °C. This leads to the high-temperature isothermal degradation of the solid oxide cells when operated at temperatures above 350 °C.

Solid symbols show the experiments in which no or nearly zero percent monoclinic phase was observed.

A series of solid oxide cells having a structural support comprising Nickel oxide/Yttria-stabilized zirconia (Ni(O)-3YSZ) with different average grain size were produced in order to test the effect of the average grain size for operational temperature above 350 °C.

In particular, four solid oxide cells having structural support comprising Nickel oxide/Yttria-stabilized zirconia (Ni(O)-3YSZ) and having an average grain-size of 309, 239, 186 and 123 nm, have been prepared and tested.

The sample notation is reported below and the operational data have been collected in table 1.

### Samples Notation

A) Ni-3YSZ_25%_309 (98) nm
B) Ni-3YSZ_35%_239(80) nm
C) Ni-3YSZ_32.5%_186(56) nm
D) Ni-3YSZ_47%_123(33) nm

The samples notation provides the average grain size with the standard deviation within parenthesis in nm. The numbers in % indicate the porosity in the reduced state, which corresponds to the porosity in the oxidized state of ≈4% (A), 17% (B), 13.5% (C), and 32% (D).

Table 1 shows the results of aging of the SOCs mentioned above at high temperatures (350, 450, and 550 °C) and in presence of ≈60% steam.

TABLE 1

| | Sample | | | | | | | | |
|---|---|---|---|---|---|---|---|---|---|
| Aging | (grain | Monoclinic phase content (%) after different | | | | | | | |
| temperature | size | aging duration (hrs) | | | | | | | |
| (°C) | nm) | 3 | 20 | 320 | 800 | 1200 | 2000 | 3000 | 4000 |
| 350 | A (309) | 17.2 | 63.3 | 72.8 | — | A | — | — | — |
| | B (239) | 0 | 0 | 1.6 | 2.5 | 2.7 | 3.3 | 4.8 | 9 |
| | C (186) | 0 | 0 | 0 | 0 | 0 | 0 | 0 | 0 |
| | D (123) | 0 | 0 | 0 | 0 | 0 | 0 | 0 | 0 |
| 450 | A (309) | 44.3 | 62.2 | 73 | — | A | — | — | — |
| | B (239) | 0 | 0 | ≈0 | 4.2 | 6.2 | 5.9 | 11 | 32 |
| | C (186) | 0 | 0 | 0 | 0 | 0 | 0 | 0 | 1.3 |
| | D (123) | 0 | 0 | 0 | 0 | 0 | 0 | 0 | 0 |
| 550 | A (309) | 11.9 | 58.7 | 73.3 | — | A | — | — | — |
| | B (239) | 0 | 0 | 0 | ≈0 | ≈0 | ≈0 | 1 | 7.3 |
| | C (186) | 0 | 0 | 0 | 0 | 0 | 0 | 0 | 0 |
| | D (123) | 0 | 0 | 0 | 0 | 0 | 0 | 0 | 0 |

It can be clearly seen that, for aging temperatures higher or equal to 350 °C, a SOC having a structural component comprising doped zirconia, i.e. Ni(O)-3YSZ, and having average grain size of 123 and 186 nm, shows ≈0% of monoclinic phase content.

It is also clear that for grain sizes bigger than 190 nm, i.e. 239 nm and 309 nm, the content of monoclinic phase is noticeable, even after few hours of operation, and become substantial, e.g. for grain size of 309 nm, after 320 hours of operation, leading to the high-temperature degradation of the solid oxide cell.

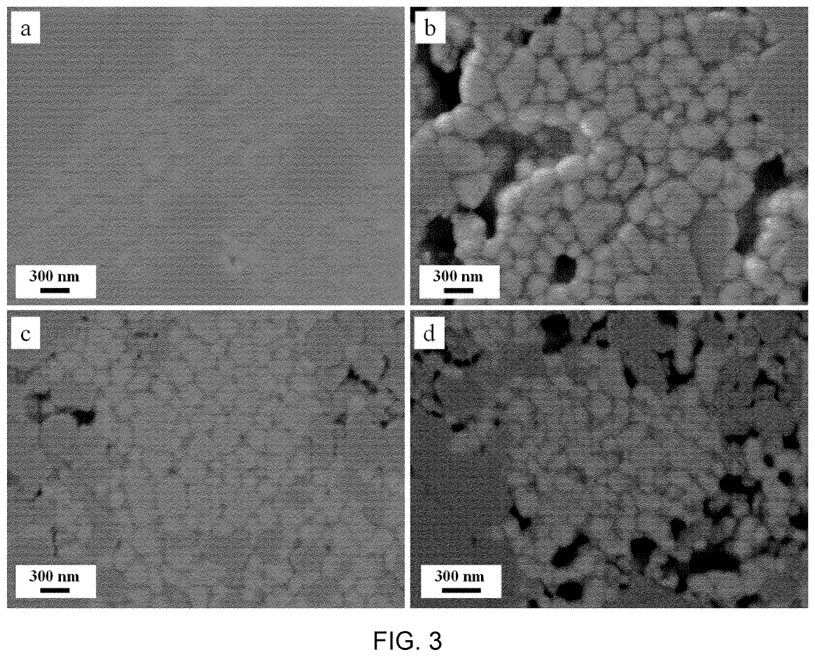

FIG. 3 shows SEM images of NiO-3YSZ samples with different average grain size of 3YSZ, a) 309 nm (sample A in Table 1), b) 239 nm (Sample B in Table 1), c) 186 nm (sample C in Table 1), and d) 123 nm (Sample D in Table 1).

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. In addition, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1-13. (canceled)

14. A solid oxide cell, comprising:
at least one porous structural component comprising yttria doped zirconia having the formula Zr₁₋ₓ Yₓ O_{2-δ},
wherein x is from 0.04 and 0.07,
wherein δ is from 0.02 and 0.035,
wherein said doped zirconia has more than 80 vol % of a metastable tetragonal crystalline phase and has an average grain-size between 120-190 nm, and
wherein the solid oxide cell is configured to be operated at a temperature between 400 and 850 °C.

15. The solid oxide cell according to claim 14, wherein said doped zirconia comprises scandium in a range lower than 14 mol %.

16. The solid oxide cell according to claim 14, wherein said doped zirconia comprises scandium in a range between 8 and 14 mol %.

17. The solid oxide cell according to claim 14, wherein said doped zirconia comprises cerium in a range lower than 15 mol %.

18. The solid oxide cell according to claim 14, wherein said doped zirconia comprises cerium in a range between 10 and 15 mol %.

19. The solid oxide cell according to claim 14, wherein said doped zirconia comprises ytterbium in a range lower than 7 mol %.

20. The solid oxide cell according to claim 14, wherein said doped zirconia comprises ytterbium in a range between 4 and 7 mol %.

21. The solid oxide cell according to claim 14, wherein said doped zirconia comprises calcium in a range lower than 9 mol %.

22. The solid oxide cell according to claim 14, wherein said doped zirconia comprises calcium in a range lower between 4 and 9 mol %.

23. The solid oxide cell according to claim 14, wherein said doped zirconia comprises magnesium.

24. The solid oxide cell according to claim 14, wherein said at least one structural component comprises a composite system of nickel oxide and doped zirconia, the composite system optionally comprising (ZrO₂)_{0.97}(Y₂O₃)_{0.03}.

25. The solid oxide cell according to claim 24, wherein said composite system has a porosity level in the oxidized form between 5 and 40%.

26. The solid oxide cell according to claim 24, wherein said composite system has a porosity level in the oxidized form between 18 and 33%.

27. The solid oxide cell according to claim 25, wherein said composite system has a porosity level in the oxidized form between 13 and 18%, optionally 13.5%.

28. The solid oxide cell, according to claim 14, wherein said at least one structural component comprises a fuel electrode structural component.

29. The solid oxide cell, according to claim 14, wherein said at least one structural component comprises an oxygen electrode structural component.

30. The solid oxide cell, according to claim 14, wherein said at least one structural component is an electrolyte.

31. The solid oxide cell according to claim 14, wherein said solid oxide cell is configured to be operated at a temperature above 400 °C.
